(19) United States
(12) Patent Application Publication
(10) Pub. No.: US 2026/0329551 A1
(43) Pub. Date: Oct. 22, 2026

(54) SYSTEMS, METHODS, AND MEDIA FOR UTILIZING A BLUEPRINT CONTAINER OF A COMPUTER ARCHITECTURE FOR AUTOMATICALLY GENERATING SOFTWARE CODE THAT SATISFIES THE PARAMETERS OF THE COMPUTER ARCHITECTURE

(71) Applicant: FMR LLC, Boston, MA (US)

(72) Inventors: Glen Jordan Byrne, Newcastle (IE); Edwin Corrigan, Galway (IE); Joshua David Hough, Raleigh, NC (US); Dipanjan Haldar, Acton, MA (US); Aneesha Vallabhaneni, Apex, NC (US)

(21) Appl. No.: 19/180,513

(22) Filed: Apr. 16, 2025

(51) Int. Cl. G06F 8/35; G06F 8/10

(52) U.S. Cl. CPC G06F 8/35; G06F 8/10

(57) ABSTRACT

Techniques are provided for utilizing a blueprint container of a computer architecture for automatically generating software code that satisfies the parameters of the computer architecture. A specification data structure may be validated utilizing blueprint containers for the computer architecture and its components. The computer architecture blueprint container can be utilized to identify a component, and the corresponding component blueprint container can be utilized to identify a location of the template data structures for the component. At least one template data structure can be updated utilizing information from the validated specification data structure, and the populated template can be executed to generate code for the component. As a result, the generated code meets the parameters of the computer architecture and its component.

### BACKGROUND

### Technical Field

The present disclosure relates generally to software code generation, and more specifically to techniques for utilizing a blueprint container of a computer architecture for automatically generating software code that satisfies the parameters of the computer architecture.

### Background Information

Modern computer architectures are increasingly complex, consisting of multiple layers such as microservices, data management, and presentation, each with distinct components that must work together seamlessly. As these architectures continue to evolve, new technologies and design paradigms enhance functionality but also introduce greater complexity in system interactions. Within this framework, software applications must be designed to execute efficiently, ensuring seamless communication across the various layers and their respective components.

The various types of layers and components within a computer architecture directly influence how the system operates, as each layer and component imposes its own set of requirements and constraints. Software applications that run on these architectures must adhere to these requirements and constraints, ensuring compatibility with the underlying structure. This makes code generation particularly challenging, especially as architectures become more complex, with multiple layers and intricate communication channels between components. Additionally, if the architecture changes, the software application may also need to be modified to maintain compatibility and satisfy the updated requirements or constraints imposed by the new or modified layers and components.

To assist in application development, code generation tools have been introduced to automate portions of the code generation process, reducing manual effort and enforcing standardized patterns. However, these tools are typically designed to function across a broad range of computer architectures rather than being customized for the specific needs of a given system, such as those managed and operated by an enterprise. For instance, enterprise applications may need to adhere to specific code quality standards, naming conventions, or regulatory requirements established by the organization or an external authority. Conventional code generation tools are not designed to accommodate these varying and evolving requirements and constraints across different architectures.

As a result, these tools often impose rigid structures that may not align with the specific design and operational needs of a given computer architecture. This forces developers to either modify their system to conform to the generated code or abandon the tool in favor of custom development. This trade-off can introduce inefficiencies/errors, increase development complexity, and lead to design compromises, making it difficult to fully leverage existing code generation tools in diverse and constantly changing computer architecture environments.

### SUMMARY

Techniques are provided for utilizing a blueprint container of a computer architecture for automatically generating software code that satisfies the parameters of the computer architecture.

Specifically, a user (e.g., developer) may utilize a client device to create a computer architecture blueprint container that defines the parameters, e.g., constraints and requirements, of the computer architecture having multiple layers. Each layer may include one or more different components. The created computer architecture blueprint container may be required to have particular fields and corresponding values, while other fields and corresponding values may be optional. In an embodiment, the computer architecture blueprint container is required to include a components field that lists one or more components of the computer architecture and a requiredMetadata field that lists values that are required to be included in a specification data structure that is used for code generation.

The user may also utilize the client device to create a component blueprint container for each component of the computer architecture. A component blueprint container may define the parameters, e.g., constraints and requirements, of the corresponding component. The created component blueprint container may be required to have particular fields and corresponding values, while other fields and corresponding values may be optional. In an embodiment, the component blueprint container is required to include a name field that indicates a name of the component, a directory field identifying the directory where the generated code will be stored, and a templates field indicating a location of one or more template data structures for the component.

A software module (e.g., blueprint code generation module) executed by a processor may validate a specification data structure utilizing the blueprint containers and then use the validated specification data structure with the blueprint containers to generate software application code for one or more different components of the computer architecture. In an embodiment, a specification data structure includes information defining interfaces, functionality, and constraints of interaction between different components in the computer architecture with the multiple layers.

The software module may analyze the specification data structure to generate an object for each parameter of the specification data structure. The software module may also analyze the computer architecture blueprint container to identify at least one component of the computer architecture. The software module may identify the component blueprint container corresponding to the identified component. The software module may identify the location of one or more template data structures for the component from the component blueprint container.

The software module may update at least one identified template data structure using information from the data object created from the validated specification data structure. The software module may then, for example, execute the populated template data structures to generate code for the component, wherein the generated code satisfies the parameters of the computer architecture and component.

### BRIEF DESCRIPTION OF THE DRAWINGS

The description below refers to the accompanying drawings, of which:

FIG. 1 is a high-level block diagram of an example system environment according to the one or more embodiments as described herein;

FIG. 2 is an example of a computer architecture blueprint container according to the one or more embodiments as described herein;

FIG. 3 is an example of a component blueprint container according to the one or more embodiments as described herein;

FIG. 4 is a flow diagram of a sequence of steps for determining if a specification data structure is valid, and generating code for a software application utilizing blueprint containers and a validated specification data structure according to the one or more embodiments as described herein;

FIG. 5 is a flow diagram of a sequence of steps for performing a validation process according to the one or more embodiments as described herein;

FIG. 6 is a flow diagram of a sequence of steps for a code generation process according to the one or more embodiments as described herein;

FIG. 7 is an example of a data object that is generated based on an analysis of a specification data structure according to the one or more embodiments as described herein; and

FIG. 8 is an example of code that is generated for a software application and that meets the parameters of a computer architecture according to the one or more embodiments as described herein.

### DETAILED DESCRIPTION OF AN ILLUSTRATIVE EMBODIMENT

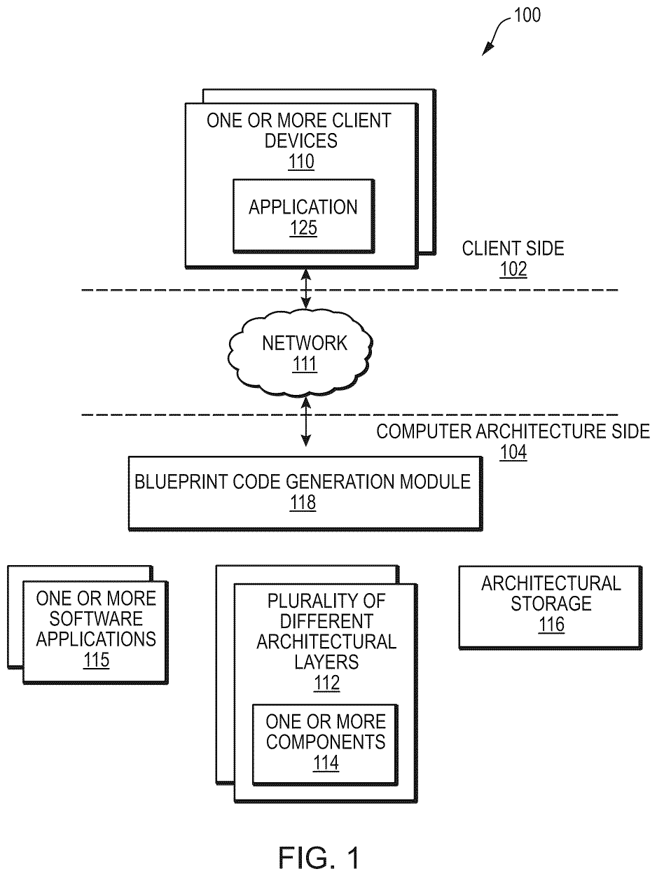

FIG. 1 is a high-level block diagram of an example system environment 100 according to the one or more embodiments as described herein. The system environment 100 may be divided into a client side 102 that includes one or more local client devices 110 that are local to end users, and a computer architecture side 104 that is remote from the ends users. As used herein, computer architecture side 104 and computer architecture 104 may be used interchangeably. Computer architecture 104 may be managed, operated, and maintained by an enterprise. In an embodiment, the enterprise may be a financial services institution.

The client side 102 may include one or more local client devices 110 that provide a variety of user interfaces and non-processing intensive functions. For example, a local client device 110 may provide a user interface, e.g., a graphical user interface and/or a command line interface, for receiving user input and displaying output according to the one or more embodiments as described herein. In an embodiment, the client device 110 may be a server, a workstation, a platform, a mobile device, a network host, or any other type of computing device. The client device 110 may be operated by, for example, customers of the enterprise. The client device 110 may also be operated by authorized personnel, e.g., employees of the enterprise, to perform enterprise functions. For example, client device 110 may download and execute application 125 that is provided by the enterprise. The execution of application 125 may allow customers and/or employees of the enterprise to implement one or more financial services functions.

The client device 110 may communicate with the computer architecture 104, managed/operated by the enterprise, over network 111. For example, a user may utilize application 125, executing on client device 110, to communicate with computer architecture 104 as will be described in further detail below.

Computer architecture 104 includes both hardware structures (not shown) and software structures, which work together to define and implement the computer architecture's functionality, performance, and efficiency. The hardware structures are omitted from FIG. 1 for simplicity and ease of understanding. The hardware structures may include, but are not limited to, a Central Processing Unit (CPU), a Graphics Processing Unit (GPU), memory components, storage devices, cache, etc. The software structures may include a plurality of different layers 112. Such layers 112 may include, but are not limited to, a microservices layer, a data layer, an integration layer, a security layer, an infrastructure layer, a domain layer, an application layer, and a presentation layer. Each layer 112 may consist of one or more components 114 that implement specific functions within its respective layer 112. The various layers 112 and their components 114 can directly impact how the computer architecture 104 operates, as each may impose its own set of requirements and constraints.

Enterprises (i.e., corporations) and individuals can develop software applications 115 (i.e., software programs) that execute within a computer architecture 104 to implement various features for customers/employees or to fulfill the desired functionality. However, for the software application 115 to run efficiently (e.g., without errors or resource wastage) the code generated for the software application 115 must satisfy, i.e., comply with, the parameters (e.g., requirements and constraints) imposed by the components 114 within the architecture 104.

With conventional systems and approaches, a myriad of existing tools assist with code generation. Since these tools are designed to generate code for a variety of different computer architectures, each with its unique layers and components, they typically implement generic features. As a result, these tools do not generate code tailored to the specific features of a particular computer architecture. Instead, the generated code is often agnostic to the nuances and specifications of the computer architecture. Consequently, program developers are left with the task of manually modifying the generated code to fit their specific architecture, modifying their existing computer architecture to fit the code, or abandoning the conventional code generation tool altogether. This can lead to more code errors and the generation of code that is not optimized for, nor well-suited to, the constraints and requirements of the computer architecture.

The blueprint code generation module 118 of computer architecture 104 may implement the one or more embodiments as described herein to overcome the deficiencies associated with conventional code generation tools. Specifically, and as will be described in further detail below, a user may utilize application 125 executing on client device 110 to create/generate (1) a computer architecture blueprint container that defines parameters (e.g., requirements and constraints) of the computer architecture 104 and (2) a component blueprint container that defines the parameters (e.g., requirements and constraints) of at least one component 114 of the computer architecture 104. The blueprint code generation module 118 may receive at least the computer architecture blueprint container and the component blueprint container.

The blueprint code generation module 118 may also receive a specification data structure that includes information defining interfaces, functionality, and constraints of interaction between different components 114 in the computer architecture 104 with the different layers 112. As will be described in further detail below, the blueprint code generation module 118 can validate the specification data structure and use the validated specification data structure with the blueprint containers to generate code, for software application 115, that satisfies or complies with the parameters of the computer architecture 104.

Therefore, the code generated according to the one or more embodiments as described herein can be automatically generated to fit the existing features and nuances of the computer architecture 104. That is, the one or more embodiments as described herein obviate the need to, for example, modify the computer architecture to match or fit the code generated by conventional data agnostic code generation tools. Accordingly, the one or more embodiments as described herein provide an improvement in the existing technological field of automatic code generation for software applications that execute within computer architectures with multiple layers.

The generated code, blueprint containers, data structures, and any other values, files, etc. that are generated and/or utilized as described herein may be stored in computer architecture storage 116.

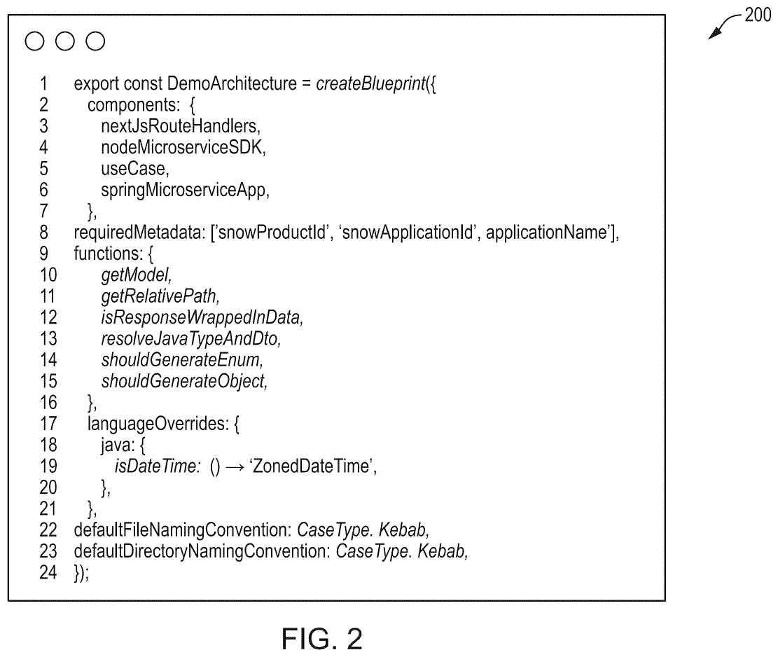

FIG. 2 is an example of a computer architecture blueprint container 200 according to the one or more embodiments as described herein. Although computer architecture blueprint container 200 of FIG. 2 is a portion of code, it is expressly contemplated that a computer architecture blueprint container may be a data structure instead of a portion of code. According to the one or more embodiments as described herein, a user may utilize application 125, which may be a software application editor, to generate the computer architecture blueprint container 200. For example, the user may utilize a plurality of different programming constructs (i.e., keywords), as will be described in further detail below, to define the different parameters of the computer architecture 104.

Code line 1 of computer architecture blueprint container 200 assigns the function named createBlueprint to the constant named DemoArchitecture. The constant is then made available for import in other modules or code portions using the export programming construct of code line 1.

Code lines 2 through 23 of computer architecture blueprint container 200 include different programming constructs and corresponding values that define the parameters of the computer architecture 104. Computer architecture blueprint container 200 may include required programming constructs and optional programming constructs as will be described in further detail below. In an embodiment, a computer architecture blueprint container 200 must include the required programming constructs and corresponding values to be valid.

Code line 2 includes the programming construct of components, which may be a required programming construct according to the one or more embodiments as described herein. The components programming construct may be utilized by a user (i.e., developer) to indicate one or more different components 114 that are included in the computer architecture 104. In this example, the names of the different components that are included in the computer architecture 104 are provided at code lines 3 through 6. As will be described in further detail below, the name of a component allows the blueprint code generation module 118 to identify and access a component blueprint container for a component that corresponds to the component name.

Code line 8 includes the programming construct of requiredMetadata, which may be a required programming construct according to the one or more embodiments as described herein. The requiredMetadata programming construct may be utilized by the user to indicate one or more values that are required to be included in a corresponding specification data structure for code generation. In this example, the values that are required to be included in the corresponding specification data structure for code generation are provided at code lines 8 and are snowProductId, snowApplicationId, and applicationName. As will be described in further detail below, the blueprint code generation module 118 can use the required values to validate or invalidate the corresponding specification data structure.

Code line 9 includes the programming construct of functions, which may be an optional programming construct according to the one or more embodiments as described herein. The functions programming construct may be utilized by the user to indicate one or more functions that are available for use with one or more template data structures corresponding to the components of computer architecture 104. In this example, the available functions are provided at code lines 10 through 15.

Code line 17 includes the programming construct of languageOverrides, which may be an optional programming construct according to the one or more embodiments as described herein. The languageOverrides programming construct may be utilized by the user to indicate a list of one or more overrides to be utilized for different types of conversions of different programming languages associated with the generated code. In this example, the language override is provided at code line 19 and indicates that any date time value, when generating the value for the Java Programming language type, overrides the default conversion value and instead uses the value ZonedDateTime.

Code line 22 includes the programming construct of defaultFileNamingConvention, which may be an optional programming construct according to the one or more embodiments as described herein. The defaultFileNamingConvention programming construct indicates a default casing that will be used for dynamic values in template file names of the computer architecture 104. In this example, the default file naming convention is provided at code line 22 and indicates that kebab casing is to be used for template file names of computer architecture 104. As known by those skilled in the art, kebab casing is a style of writing where words are lowercase and separated by hyphens. In an embodiment, if the programming construct of defaultFileNamingConvention is not utilized in computer architecture blueprint container 200, then the default casing for template file names may be the kebab casing.

Code line 23 includes the programming construct of defaultDirectoryNamingConvention, which may be an optional programming construct according to the one or more embodiments as described herein. The defaultDirectoryNamingConvention programming construct may indicate a default casing that will be used for dynamic values in directory file names of computer architecture 104. In this example, the default directory naming convention is provided at line 22 and indicates that kebab casing is to be used for template directory names of computer architecture 104. In an embodiment, if the programming construct of defaultDirectoryNamingConvention is not utilized in computer architecture blueprint container 200, then the default casing for template directory names may be the kebab casing.

Therefore, a developer may utilize the different programming constructs as described herein and in relation to FIG. 2 to define different parameters of computer architecture 104. Therefore, a different computer architecture blueprint container 200 may be generated for each of a variety of different computer architectures and stored in architecture storage 116. Therefore, and as will be described in further detail below, each different computer architecture blueprint container 200 may be utilized by blueprint code generation module 118 to automatically generate code that meets the parameters of different computer architectures.

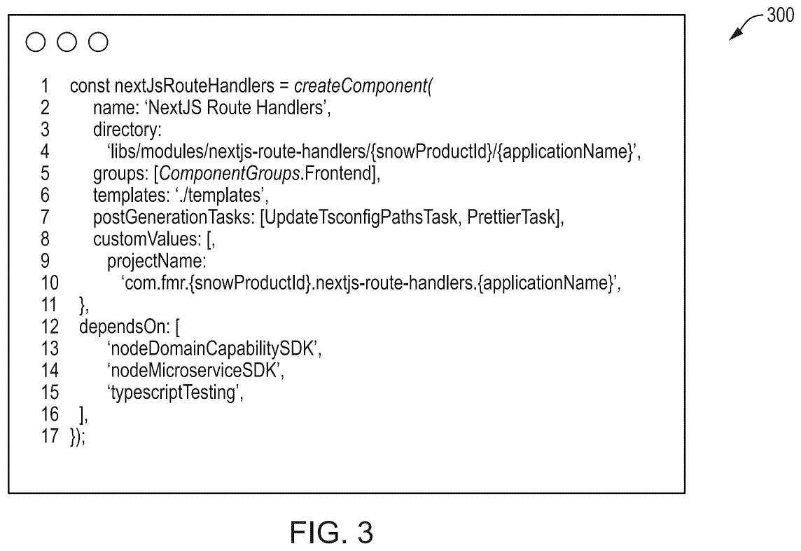

FIG. 3 is an example of a component blueprint container 300 according to the one or more embodiments as described herein. Although component blueprint container 300 of FIG. 3 is a portion of code, it is expressly contemplated that a computer architecture blueprint container may be a data structure instead of a portion of code. According to the one or more embodiments as described herein, a user may utilize application 125, which may be a software application editor, to generate the component blueprint container 300. For example, the user may utilize a plurality of different programming constructs (i.e., keywords), as will be described in further detail below, to define the different parameters of the component 114.

For this example, let it be assumed that a developer creates component blueprint container 300 for a route handler component 114 in a data layer 112 that is responsible for handling HTTP requests, managing the flow of data within the backend of software application 115, and ensuring that responses are returned in the appropriate format.

Code line 1 of component blueprint container 300 assigns the function named createComponent to the constant named nextJsRouteHandlers. In an embodiment, the name of the constant matches the name of a component included in the computer architecture blueprint container 200. In this example, nextJsRouteHandlers at code line 1 of component blueprint container 300 matches the component name at code line 3 of the computer architecture blueprint container 200.

Code lines 2 through 15 of component blueprint container 300 include different programming constructs and corresponding values that define the parameters of the component. A component blueprint container may include required programming constructs and optional programming constructs as will be described in further detail below. In an embodiment, a component blueprint container 300 must include the required programming constructs and corresponding values to be valid.

Code line 2 includes programming construct name, which may be a required programming construct according to the one or more embodiments as described herein. The name programming construct may be utilized, according to the one or more embodiments as described herein, to identify and differentiate the component from other components. For example, and according to the one or more embodiments as described herein, the name at code line 2 may be presented to a user in a graphical user interface so that the user can select the component and the corresponding component blueprint container 300 can be identified. In an embodiment, the name may be any combination of alpha numeric values that uniquely identifies and differentiates the component from all other components. In this example, code line 2 indicates that the name of the component is NextJS Route Handlers.

Code line 3 includes programming construct directory, which may be a required programing construct according to the one or more embodiments as described herein. The directory programming construct may be utilized to indicate the directory into which the output, with the generated code for the component, will be stored. In this example, code line 4 indicates the directory.

Code line 5 includes programming construct groups, which may be an optional programming construct according to the one or more embodiments as described herein. The groups programming construct may indicate a group that the component is a part of, wherein a group includes at least two components. In an embodiment, the blueprint code generation module 118 generates code for all the components in the group as part of the same process. In this example, code line 5 indicates that a group exists for all components that belong to the front end of the software application 115. For example, the components that belong to the front end may include, but are not limited to, business logical, state management, software development kits (SDKs), data layer, etc.

Code line 6 includes programming construct templates, which may be a required programming construct according to the one or more embodiments as described herein. The templates programming construct may indicate the location where the template data structures, corresponding to the component, are stored. In this example, code line 6 indicates that the template data structures for the component are stored in the subdirectory or folder named templates.

Code line 7 includes programming construct postGenerationTasks, which may be an optional programming construct according to the one or more embodiments as described herein. The postGenerationTasks programming construct may indicate the tasks that can be run/executed after the code for the corresponding component is generated. In this example, code line 7 indicates that the tasks named UpdateTsconfigPathsTask and PrettierTask are the two tasks that should be executed after the code for the component is generated.

Code line 8 includes programing construct customValues, which may be an optional programming construct according to the one or more embodiments as described herein. The customValues programming construct may indicate custom values that are accessible from within the templates that correspond to the component. In this example, code lines 9 and 10 indicate that the component has a custom value named projectName that is assigned a value of com.fmr.{snowProductId}.nextjs-route-handlers.{applicationName}. The value at code line 10 is accessible to all templates that are part of the component. According to the one or more embodiments as described herein, snowProductId and applicationName are metadata values from the blueprint container and are dynamically replaced during code generation.

Code line 12 includes programing construct dependsOn, which may be an optional programming construct according to the one or more embodiments as described herein. The dependsOn programming construct may indicate a list of one or more other components that the component corresponding to FIG. 3 depends on. In this example, code lines 13 through 15 indicate the three components that the component corresponding to FIG. 3 depends on.

Although not included in component blueprint container 300, there may be other optional programming constructs according to the one or more embodiments as described herein. For example, programming construct preGenerationTasks may be an optional programming construct according to the one or more embodiments as described herein. The preGenerationTasks may indicate the tasks that can be run/executed before the code for the corresponding component is generated. Further, programming constructs defaultFileNamingConvention and defaultDirectoryNamingConvention may be optional programming constructs for a component blueprint container according to the one or more embodiments as described herein. The programming constructs defaultFileNamingConvention and defaultDirectoryNamingConvention for the component are similar to those as described in relation to FIG. 2.

However, the values provided for the programming constructs of defaultFileNamingConvention and defaultDirectoryNamingConvention for the component will take precedence over the same programming constructs for the computer architecture. For example, let it be assumed that component blueprint container 300 indicates that the type of casing for the dynamic values for the template files of component nextJsRouteHandlers is camel casing. Therefore, components named nodeMicroserviceSDK, useCase, and springMicroserviceApp will use kebab casing for dynamic values of the template data structures. However, because the file naming convention of component blueprint container 300 takes precedence over computer architecture blueprint container 200, nextJsRouteHandlers uses camel casing for the dynamic values of the template data structures.

Therefore, a developer may utilize the different programming constructs as described herein and in relation to FIG. 3 to generate a component blueprint container for each different component 114 of a computer architecture 104. For example, let it be assumed that a computer architecture 104 includes 10 different components 114. According to the one or more embodiments as described herein, a user can create a computer architecture blueprint container for the computer architecture 104 and can also create a component blueprint container for each of the 10 different components 114 of the computer architecture 104.

The blueprint code generation module 118 can then automatically generate code that meets or satisfies the parameters of the computer architecture 104 and its components 114 using the blueprint containers for the computer architecture and the different components as will be described in further detail below. As a result, the blueprint code generation module 118 can dynamically and automatically generate code for different computer architectures, having different parameters, using their corresponding blueprint containers according to the one or more embodiments as described herein.

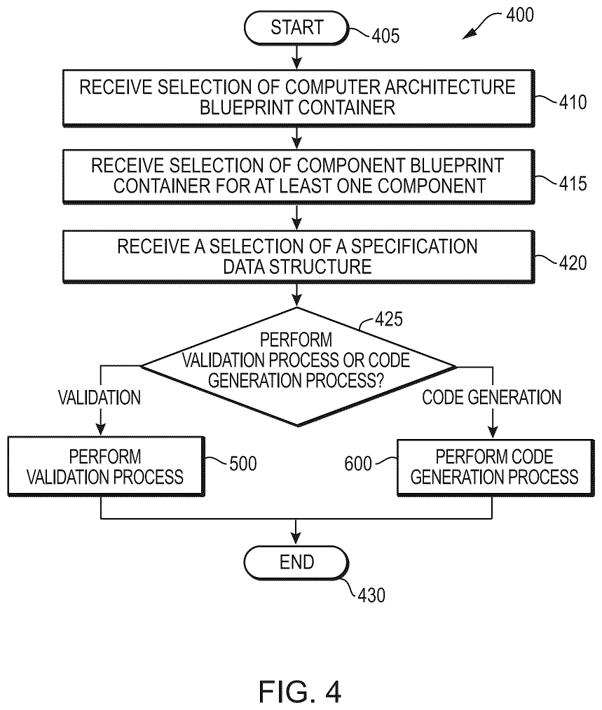

FIG. 4 is a flow diagram of a sequence of steps for determining if a specification data structure is valid, and generating code for a software application utilizing blueprint containers and a validated specification data structure according to the one or more embodiments as described herein. The procedure 400 starts at step 405 and continues to step 410. At step 410, the blueprint code generation module 118 receives a selection of a computer architecture blueprint container.

In an embodiment, the blueprint code generation module 118 may generate a list of one or more computer architecture blueprint containers that are previously generated and then stored in architecture storage 116. The blueprint code generation module 118 may display the list on application 125 to a user. The user may utilize a pointing device (e.g., mouse) to select a particular computer architecture blueprint from the list, and the selection may be provided to the blueprint code generation module 118. The blueprint code generation module 118 may use the selection to identify and obtain the corresponding computer architecture blueprint container from architecture storage 116.

For this example, let it be assumed that the blueprint code generation module 118 receives a selection for computer architecture blueprint container 200 of FIG. 2, and then obtains computer architecture blueprint container 200 from architecture storage 116.

The procedure continues from step 410 to step 415. At step 415, the blueprint code generation module 118 receives a selection of a component blueprint container for at least one component 114 of the computer architecture 104.

In an embodiment, the blueprint code generation module 118 may generate a list of one or more component blueprint containers that are previously generated and then stored in architecture storage 116. The blueprint code generation module 118 may display the list on application 125 to a user. The user may utilize a pointing device (e.g., mouse) to select one or more component blueprint containers from the list, and the selection may be provided to the blueprint code generation module 118. The blueprint code generation module 118 may use the selection to identify and obtain the corresponding component blueprint container from architecture storage 116.

For this example, let it be assumed that the blueprint code generation module 118 receives a selection for component blueprint container 300 of FIG. 3, and then obtains component blueprint container 300 from architecture storage 116.

The procedure continues from step 415 to step 420. At step 420, the blueprint code generation module 118 receives a selection of a specification data structure.

In an embodiment, the blueprint code generation module 118 may generate a list of one or more specification data structures that are potentially compatible with the computer architecture 104. For example, the blueprint code generation module 118 may perform any of a variety of different known analyses of the computer architecture to determine one or more specification data structures that might be compatible with the computer architecture 104. The blueprint code generation module 118 may generate a list of the potentially compatible specification data structures. The blueprint code generation module 118 may display the list on application 125 to a user. The user may utilize a pointing device (e.g., mouse) to select a particular specification data structure, and the selection may be provided to the blueprint code generation module 118. The blueprint code generation module 118 may use the selection to identify and obtain the corresponding specification data structure from architecture storage 116.

The procedure continues from step 420 to step 425. At step 425, the blueprint code generation module 118 determines if an indication has been received to either perform a validation process or perform a code generation process. In an embodiment, the blueprint code generation module 118 may receive the indication over the network 111 and from client device 110. For example, a user may utilize application 125 executing on client device 110 to indicate whether to perform the validation process or the code generation process.

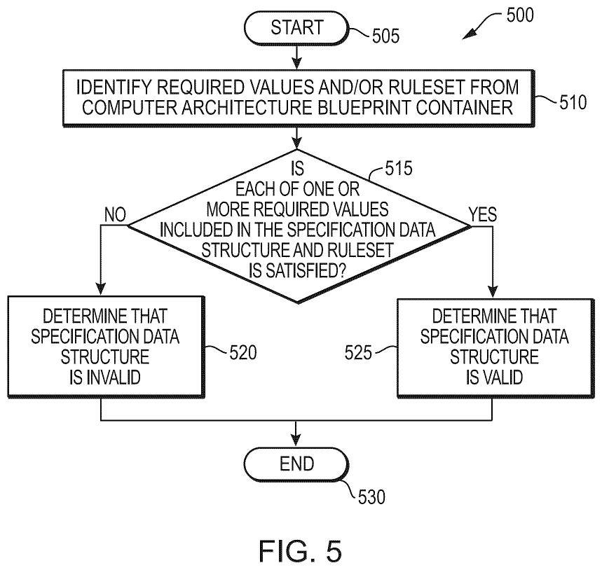

If at step 425 the blueprint code generation module 118 determines that an indication has been received to perform the validation process, the procedure continues to step 500. At step 500, the blueprint code generation module 118 performs the validation process. FIG. 5 is a flow diagram of a sequence of steps for performing a validation process according to the one or more embodiments as described herein. The flow diagram of FIG. 5 describes determining if the specification data structure, selected at step 420 of FIG. 4, can or cannot be used for code generation according to the one or more embodiments as described herein.

The procedure 500 starts at step 505 and continues to step 510. At step 510, the blueprint code generation module 118 identifies the required values from the computer architecture blueprint container. For the example as described herein, the blueprint code generation module 118 may syntactically analyze computer architecture blueprint container 200 to identify the requiredMetadata field (i.e., programming construct) at code line 8. Once the requiredMetadata field at code line 8 is identified, the blueprint code generation module 118 may syntactically identify the required values that follow the colon and that are between the brackets at code line 8. Therefore, and in this example, the three required values are snowProductId, snowApplicationId, and applicationName.

Further, an enterprise may have ruleset that must be complied with so that code generation may proceed. Stated differently, the ruleset may be requirements for the generated code and the requirements have to be satisfied for the generated code to, for example, execute on the computer architecture 104. For example, the ruleset may include, but is not limited to, coding standard, particular values included in the specification data structure, etc.

The procedure continues from step 510 to step 515. At step 515, the blueprint code generation module 118 determines if each of the one or more required values is included in the received specification data structure and if the ruleset is satisfied. Continuing with the example, the blueprint code generation module 118 determines if each of snowProductId, snowApplicationId, and applicationName are included in the specification data structure received at step 420 of FIG. 4. For example, the blueprint code generation module 118 may syntactically analyze the specification data structure to determine if the identifier of snowProductId is included in the specification data structure and has a corresponding value. The blueprint code generation module 118 may perform a similar syntactical analysis for snowApplicationId, and applicationName.

For the ruleset, the blueprint code generation module 118 may determine if a particular field of the specification data structure includes a particular value. If so, the blueprint code generation module 118 may determine that the ruleset is satisfied. If not, the blueprint code generation module 118 may determine that the ruleset is not satisfied. For example, let it be assumed that the specification data structure includes a reference to a “get” operation type. The blueprint code generation module 118 may determine whether the operationId field of the specification data structure includes a value that starts with “get”. If so, the blueprint code generation module 118 can determine that the ruleset is satisfied. If not, the blueprint code generation module 118 can determine that the ruleset is not satisfied. The example in relation to the ruleset is for illustrative purposes only, and it is expressly contemplated that any of a variety of rules may be utilized and evaluated to validate the specification data structure according to the one or more embodiments as described herein.

If at least one required value is not included in the specification data structure or if the ruleset is not satisfied, the procedure continues from step 515 to step 520. At step 520, the blueprint code generation module 118 determines that the specification data structure is invalid. In an embodiment, the blueprint code generation module 118 may generate an output indicating the specification data structure is invalid and/or the reason for its invalidity. For example, the blueprint code generation module 118 may generate an output that states “Specification data structure is invalid because a required value is missing.”

If all the required values are included in the specification data structure and the ruleset is satisfied, the procedure continues from step 515 to step 525. At step 525, the blueprint code generation module 118 determines that the specification data structure is valid. In an embodiment, the blueprint code generation module 118 may generate an output indicating the specification data structure is valid. For example, the blueprint code generation module 118 may generate an output that states “Specification data structure is valid.”

The procedure continues from steps 520 and 525 to step 530. The procedure 500 ends at step 530. Referring back to FIG. 4, after the validation process is performed at step 500, the procedure 400 continues to step 430 and ends.

Therefore, and as described in relation to FIG. 5, the one or more embodiments as described herein can determine if the selected specification data structure is suitable to be used for code generation or not. Therefore, the one or more embodiments as described herein provide an improvement in the existing technological field of code generation for software applications.

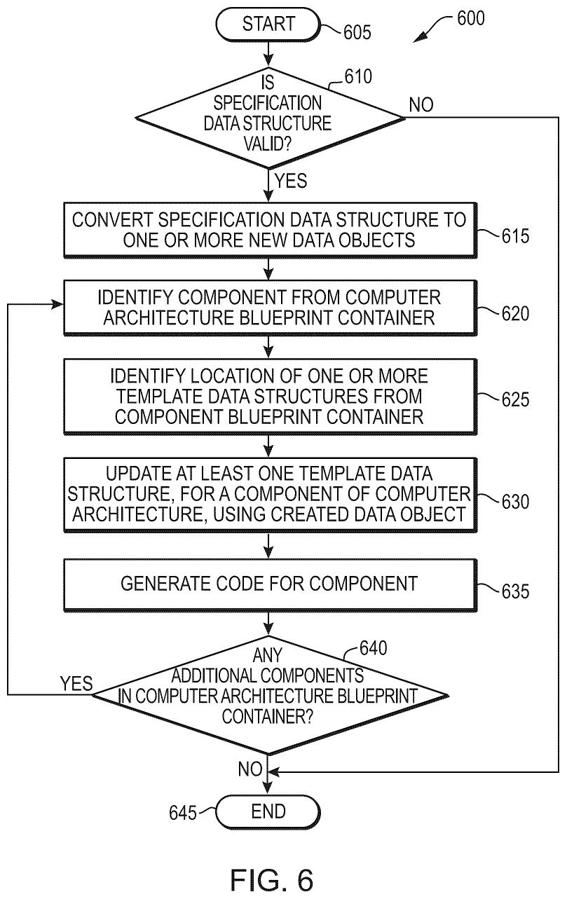

Referring back to step 425 of FIG. 4, if at step 425 the blueprint code generation module 118 determines that an indication has been received to perform the code generation process, the procedure 400 continues to step 600. FIG. 6 is a flow diagram of a sequence of steps for a code generation process according to the one or more embodiments as described herein. The procedure 600 starts at 605 and continues to step 610. At step 610, the blueprint code generation module 118 determines if the specification data structure is valid or invalid as described above in relation to FIG. 5. If the blueprint code generation module 118 determines that the specification data structure is invalid, the procedure continues from step 610 to step 645 and the procedure ends.

If the blueprint code generation module 118 determines that the specification data structure is valid, the procedure continues from step 610 to step 615. At step 615, the blueprint code generation module 118 converts the specification data structure to one or more new data objects. In an embodiment, the blueprint code generation module 118 analyzes the specification data structure to calculate several data properties that are included as part of a new data object. In an embodiment, the blueprint code generation module 118 is preconfigured to know which data properties are to be calculated.

A specification data structure may include information defining interfaces, functionality, and constraints of interaction between different components 114 in the computer architecture 104 with the multiple layers 112. In some embodiments, the specification data structure may define the structure and behavior of an application program interface (API), ensuring that software application 115 can effectively interact with computer architecture 114.

The specification data structure typically includes a paths section that defines the available endpoints of the software application 115. Each endpoint may contain multiple operations corresponding to different HTTP methods (e.g., get, post, put, and delete). A specification data structure for a single operation may include only one HTTP method (e.g., get) that defines how the single operation should function. In addition to the paths section, the specification data structure may include fields such as, but not limited to, operationId, tags, summary, description, parameters, and responses, all of which may define the behavior of the API.

The parameters field, for example, may indicate the required input for the operation, with each parameter containing multiple attributes (e.g., name, in, required, and type) that define the parameter's role for the operation. The parameters along with the other fields are utilized to ensure that the API of the software application 115 functions and integrates correctly with the computer architecture 104 (e.g., the software system of the computer architecture) to implement the operation. It is expressly contemplated that a specification data structure may include additional sections, fields, and/or parameters than those described herein. Therefore, it should be understood that the specification data structure as described herein is for illustrative purposes only.

As an illustrative example, let it be assumed that the specification data structure is for a get integrations operation. A portion of the specification data structure may be as follows:

1. paths:

| 2. | /discovery/integrations: | |
|---|---|---|
| 3. | get: | |
| 4. | operationId: getIntegrations | |
| 5. | tags: | |
| 6. | - | integrations |
| 7. | summary: Provide a list of integrations | |
| 8. | description: Retrieve a list of integrations | |
| 9. | parameters: | |
| 10. | - | name: deploymentEnv |
| 11. | | in: query |
| 12. | | required: false |
| 13. | | schema: |
| 14. | | $ref: ‘#/components/schemas/DeploymentEnvironment’ |
| 15. | | description: The deployment environment of the integrations |
| 16. | | examples: |
| 17 | | dev: |
| 18. | | value: dev |
| 19. | | summary: A sample deployment environment value |
| 20. | | description: A sample deployment environment value |

| | |
|---|---|
| 21. | responses: |
| 22. | ‘200’: |

According to the one or more embodiments as described herein, the blueprint code generation module 118 may syntactically analyze the specification data structure. Based on the analysis, the blueprint code generation module 118 can identify different parameter fields and/or attributes to generate the new data object according to the one or more embodiments as described herein. In an embodiment, the blueprint code generation module 118 generates a different data object for each parameter of the specification data structure. In an embodiment, the different data object, which are generated for each parameter, together form a singular new data object for the software application.

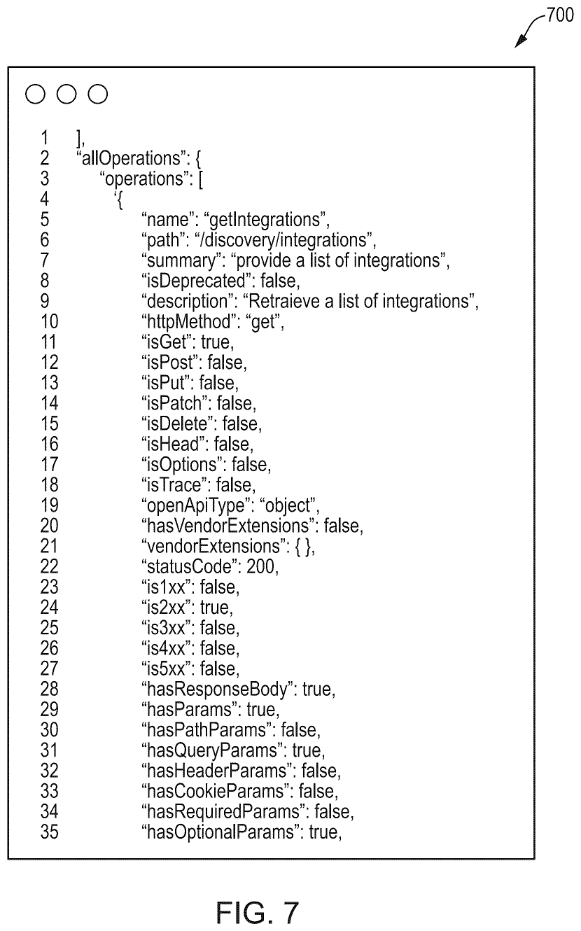

FIG. 7 is an example of a data object that is generated based on an analysis of a specification data structure according to the one or more embodiments as described herein. The blueprint code generation module 118 may generate data object 700 based on the analysis of the above specification data structure and the identification of particular corresponding values.

For example, the blueprint code generation module 118 may analyze the specification data structure, as seen above, and determine that the specification data structure includes the get method at code line 3. The blueprint code generation module 118 may populate the “isGet” field at code line 11 of the data object 700 with a value of “true”, and the “httpMethod” field at code line 10 of the data object 700 with a value of “get”. Because the blueprint code generation module 118 determines that the operation only utilizes the get method, the blueprint code generation module 118 can determine that the other HTTP methods (e.g., post, put, patch, delete, head, options, and trace) are not utilized. As such, the blueprint code generation module 118 can populate the “isPost” field, the “isPut” field, the “isPatch” field, the “isDelete” field, the “isHead” field, the “isOptions” field, and the “isTrace” field at code lines 12 through 18 with a value of “false” as depicted in FIG. 7.

Moreover, the blueprint code generation module 118 may analyze the specification data structure, as seen above, and identify the “in” attribute of the parameters field. Because the “in” attribute has a value of “query”, the blueprint code generation module 118 can determine that the corresponding parameter (e.g., named deploymentEnv) is a query parameter that is expected to be included in a URL query string rather than in a request body, header, or path. Therefore, the blueprint code generation module 118 can determine that the parameter for the operation includes query parameters and does not include path parameters, header parameters, and cookie parameters. As such, the blueprint code generation module 118 can populate the “hasParams” field at code line 29 and the “hasQueryParams” field at code line 31 of the data object 700 with a value of “true” as depicted in FIG. 7. Further, the blueprint code generation module 118 can populate the “hasPathParams” field, the “hasHeaderParams” field, and the “hasCookieParams” field at code lines 30, 32, and 33 of the data object 700 with a value of “false” as depicted in FIG. 7.

Because the required attribute at code line 12 is false in the specification data structure as seen above, the blueprint code generation module 118 can also determine that the parameter for the operation is not a required parameter and is instead an optional parameter. Accordingly, the blueprint code generation module 118 can populate the “hasOptionalParams” field at code line 35 of the data object 700 with a value of “true” and the “hasRequiredParams” field at code line 34 of the data object 700 with a value of “false”.

Additionally, the blueprint code generation module 118 may identify the response type as 200 at code lines 20 and 21 of the specification data structure as seen above. Accordingly, the blueprint code generation module 118 can populate the “status code” field at code line 22 of the data object 700 with a value of “200” and the “is2xx” field at code line 24 of the data object 700 with a value of “true” as depicted in FIG. 7. Other fields for other types of responses, e.g., “is1xx”, “is3xx”, “is4xx”, and “is5xx”, at code lines 23 and 25-27 of the data object 700 may be populated with a value of “false”.

Therefore, the blueprint code generation module 118 may analyze the specification data structure and identify particular values contained therein to generate data object 700 as described above.

Referring back to FIG. 6, the procedure continues from step 615 to step 620. At step 620, the blueprint code generation module 118 identifies a component from the selected computer architecture blueprint container. Continuing with the example, the blueprint code generation module 118 may analyze the computer architecture blueprint container 200 of FIG. 2, from top to bottom, to identify component nextJsRouteHandlers at code line 3.

The procedure continues from step 620 to step 625. At step 625, the blueprint code generation module 118 identifies a location of one or more template data structures from the component blueprint container. Continuing with the example, the blueprint code generation module 118 identifies component nextJsRouteHandlers at step 620. The blueprint code generation module 118 may then identify the corresponding component blueprint container 300 based on a match with the name of the constant at code line 1 of component blueprint container 300. The blueprint code generation module 118 may identify code line 6 of component blueprint container 300 that indicates the location where the template data structures, corresponding to the component nextJsRouteHandlers, are stored.

The procedure continues from step 625 to step 630. At step 630, the blueprint code generation module 118 updates at least one template, for a component 114 of the computer architecture, using the created data object. Continuing with the example, the blueprint code generation module 118 updates at least one template that is stored at the location identified at step 625. For example, the blueprint code generation module 118 may syntactically analyze the template to identify one or more fields that require a value. As an illustrative example, let it be assumed that the component nextJsRouteHandlers has the following template:

| | |
|---|---|
| 1. | <%_if [symbol] _%> |
| 2. | const queryParams: string[ ] = [ |
| 3. | <%_ operation.queryParams. forEach(parameter → { _%> |
| 4. | <%_ if (parameter.isRequired) { _%> |
| 5. | ‘<%= Camel( [symbol] ≥${<%= Camel(parameter.name) _%> |
| 6. | <% if (!parameter.isString \|\| parameter.isArray) { %>.toString( )<% } %> }’, |
| 7. | <%_ } _%> |
| 8. | <%_ }) _%> |
| 9. | ]; |
| 10. | |
| 11. | <%_ operation.queryParams.forEach(parameter →{ _%> |
| 12. | <%_ if ( [symbol] { _%> |
| 13. | if (<%= Camel(parameter.name) _%> ) { |
| 14. | queryParams.push(‘<%= Camel(parameter.name) _%≥${<%= |

Camel(parameter.name) _%>

| | |
|---|---|
| 15. | <% if [symbol] { %>.toString( )<% } %> }’); |
| 16. | } |
| 17. | <%_ } _%> |
| 18. | |
| 19. | <%_ }) _%> |
| 20. | Endpoint += ‘?${queryParams.join( ‘&’ )}’; |
| 21. | <%_ } _%> |

[symbol]

indicates data missing or illegible when filed

The blueprint code generation module 118 may syntactically analyze the template to identify one or more parameter fields in the template that require a value. For example, and as depicted with rectangular boxes, operation.hasQueryParams, parameter.name, parameter.isRequired, parameter.isString, and parameter.isArray are parameter fields of the template that require values. According to the one or more embodiments as described herein, the blueprint code generation module 118 may populate the values of the parameter fields of the template using data from the data object 700 generated (i.e., converted) at step 615.

For example, the blueprint code generation module 118 may identify operation.hasQueryParams with the “if” statement at code line 1 of the template as seen above. Based on the identification, the blueprint code generation module 118 may identify the corresponding hasQueryParam field at code line 31 of the data object 700 that has a value of “true”. The blueprint code generation module 118 may then replace operation.hasQueryParams at code line 1 of the template with the value of “true”.

The blueprint code generation module 118 may identify parameters.isRequired with the “if” statement at code line 4 of the template. Based on the identification, the blueprint code generation module 118 may identify the corresponding hasRequiredParams at code line 34 of the data object 700 that has a value of “false”. The blueprint code generation module 118 may then replace hasRequiredParams with the value of “false”.

The blueprint code generation module 118 may similarly replace the other parameter fields of the template data structure with corresponding values from the data object 700. Once each parameter field that requires a value is populated using the data object 700 by the blueprint code generation module 118, a populated template is generated.

The procedure continues from step 630 to step 635. At step 635, the blueprint code generation module 118 utilizes the populated template to generate code for the software application 115 and component 114 of the computer architecture 104. Specifically, the blueprint code generation module 118 may process the populated template corresponding to the component 114 to generate code, for the software application 115, that satisfies the characteristics/parameters of the component 114.

Continuing with the example, operation.hasQueryParams with the “if” statement at code line 1 is replaced with the value of “true”. Because the if condition at code line 1 is satisfied with the value of “true”, the generated code for the component 114 includes “const queryParams: string [ ]=[ ];” corresponding to code line 2. Further, parameters.isRequired with the “if” statement at code line 4 is replaced with the value of “false”. Because the if condition at code line 4 is not satisfied with the value of “false”, the generated code for the component 114 does not include the subsequent code at code lines 5 and 6.

The blueprint code generation module 118 processes the remaining portion of the populated template such that the generated code for the component 114 includes code lines 14 and 20.

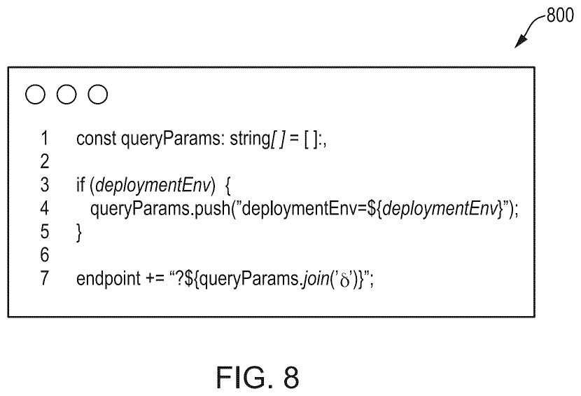

FIG. 8 is an example of code that is generated for a software application and that meets the parameters of a computer architecture according to the one or more embodiments as described herein. As depicted in FIG. 8, generated code 800 includes code from lines 2, 14, and 20 from the populated template based on whether the conditions are satisfied or not satisfied using the values from the data object 700. The generated code also includes the parameter name of deploymentEnv. In an embodiment, the blueprint code generation module 118 may store the generated code in the directory identified in the component blueprint container. For this example, the blueprint code generation module 118 may store the generated code in the directory identified at code line 4 of component blueprint container 300.

Therefore, the specification data structure is validated as complying with the blueprint containers as described herein and that include the parameters of the computer architecture 104 and its components 114. The validated specification data structure is then converted to a data object that is used to generate code for the software application 115. As a result, the generated code for the software application 115 complies with the parameters of the computer architecture 104. Stated differently, because the data object is generated from the specification data structure that is validated using the blueprint containers as described herein, the code that is generated from the data object satisfies the parameters of the computer architecture.

Accordingly, the generated code will satisfy the constraints and requirements when it executes on the computer architecture 104 and its underlying components 114. Accordingly, the one or more embodiments as described herein provide a code generation technique that automatically generates code that meets the constraints and requirements of a computer architecture 104. Therefore, the one or more embodiments as described herein provide an improvement in the existing technological field of code generation for software applications.

Referring back to FIG. 6, the procedure 600 continues from step 635 to step 640. At step 640, the blueprint code generation module 118 determines if there are any additional components in the computer architecture blueprint container for which code needs to be generated. Continuing with the example, the blueprint code generation module 118 identified the component nextJsRouteHandlers at code line 3 of computer architecture blueprint container 200 at step 620. As such, the blueprint code generation module 118 may determine that there are three additional components at code lines 4 through 6 of computer architecture blueprint container 200. Therefore, the procedure reverts to step 620 and the blueprint code generation module 118 generates code, in a similar manner as described above, for the next component, which, in this example, is component nodeMicroserviceSDK. Accordingly, the blueprint code generation module 118 can generate code for each component included in the computer architecture blueprint container 200 in a similar manner as described above and in relation to FIG. 6. After code is generated for each component included in the computer architecture blueprint container, the procedure continues from step 640 to step 645 and the procedure ends.

Referring back to FIG. 4, after the code generation process is performed at step 600, the procedure 400 continues to step 430 and ends.

In an embodiment, the generated code for a component may include a manifest file that keeps track of the files and directories generated by blueprint code generation module 118. For example, after generating code for the component, the blueprint code generation module 118 can compare the information in the manifest file with a list of files and directories generated based on a current execution of the software application 115. The blueprint code generation module 118 may delete the files and directories that are included in the manifest file but not in the list corresponding to the current execution. As a result, old and unnecessary files and directories are automatically removed according to the one or more embodiments as described herein.

It should be understood that a wide variety of adaptations and modifications may be made to the techniques. For example, the steps of the flow diagrams as described herein may be performed sequentially, in parallel, or in one or more varied orders. In general, functionality may be implemented in software, hardware or various combinations thereof. Software implementations may include electronic device-executable instructions (e.g., computer-executable instructions) stored in a non-transitory electronic device-readable medium (e.g., a non-transitory computer-readable medium), such as a volatile memory, a persistent storage device, or other tangible medium. Additionally, it should be understood that the term user and customer may be used interchangeably. Hardware implementations may include logic circuits, application specific integrated circuits, and/or other types of hardware components. Further, combined software/hardware implementations may include both electronic device-executable instructions stored in a non-transitory electronic device-readable medium, as well as one or more hardware components. Above all, it should be understood that the above description is meant to be taken only by way of example.

1. A computer-implemented method for generating code for a software application executing in a computer architecture with multiple layers each including at least one component, the computer-implemented method comprising:
receiving, by a software module executed by a processor, a computer architecture blueprint container including a plurality of computer architecture parameters that define the computer architecture;
identifying, by the software module, a component identifier from the plurality of computer architecture parameters, wherein the component identifier corresponds to a particular component in the computer architecture;
identifying, by the software module, a component blueprint container corresponding to the component identifier, wherein the component blueprint container includes a plurality of component parameters that define the particular component;
identifying, by the software module, a location identifier from the plurality of component identifiers, the location identifier indicating a location of one or more template data structures in the computer architecture, wherein each of the one or more template data structures is executable and defines an operation or configuration of the particular component;
receiving, by the software module, a specification data structure including information defining interfaces, functionality, and constraints of interaction between different components in the computer architecture with the multiple layers; and
replacing, by the software module, at least one value from each of the one or more template data structures using information from the specification data structure to generate one or more populated template data structures; and
executing, by the software module, each of the one or more populated template data structures to generate the code for the component of the computer architecture, wherein the code, when executed in the computer architecture, implements at least one function of the software application.

2. The computer-implemented method of claim 1, wherein
the plurality of computer architecture parameters define constraints and requirements of the computer architecture and the plurality of component parameters define constraints and requirements of the particular component; and
the code, when executed in the computer architecture, complies with (1) the constraints and requirements of the computer architecture and (2) the constraints and requirements of the particular component.

3. The computer-implemented method of claim 1, wherein the multiple layers include at least two of a microservices layer, a data layer, an integration layer, a security layer, an infrastructure layer, a domain layer, an application layer, and a presentation layer.

4. The computer-implemented method of claim 1, the computer-implemented method further comprising:
identifying, by the software module, a directory identifier from the plurality of component parameters included in the component blueprint container; and
writing the code to a directory corresponding to the directory identifier.

5. The computer-implemented method of claim 4, the computer-implemented method further comprising:
executing the software application in the computer architecture; and
calling, by the software application, the code stored in the directory to implement the at least one function.

6. The computer-implemented method of claim 1, wherein the plurality of computer architecture parameters include a required metadata parameter with a list of values that are required for the specification data structure.

7. The computer-implemented method of claim 6, the computer-implemented method further comprising:
identifying the list of values from the computer architecture blueprint container;
determining that the specification data structure is valid if each value from the list of values is included in the specification data structure; and
determining that the specification data structure is invalid if at least one value from the list of values is not included in the specification data structure.

8. The computer-implemented method of claim 1, the computer-implemented method further comprising:
generating, based on the generation of the code, a manifest data structure for the particular component that includes all files and directories generated for the particular component utilizing the computer architecture blueprint container and the component blueprint container;
utilizing the manifest data structure to identify one or more selected files and directories that are included in the manifest data structure but are not generated based on a current execution of the software application; and
deleting the one or more selected files and directories.

9. A system for generating code for a software application executing in a computer architecture with multiple layers each including at least one component, the system comprising:
a memory;
a processor coupled to the memory, the processor executing a software module configured to:
receive a computer architecture blueprint container including a plurality of computer architecture parameters that define the computer architecture;
identify a component identifier from the plurality of computer architecture parameters, wherein the component identifier corresponds to a particular component in the computer architecture;
identify a component blueprint container corresponding to the component identifier, wherein the component blueprint container includes a plurality of component parameters that define the particular component;
identify a location identifier from the plurality of component identifiers, the location identifier indicating a location of one or more template data structures in the computer architecture, wherein each of the one or more template data structures is executable and defines an operation or configuration of the particular component when the particular component executes in the computer architecture;
receive a specification data structure including information defining interfaces, functionality, and constraints of interaction between different components in the computer architecture with the multiple layers;
replace at least one value from each of the one or more template data structures using information from the specification data structure to generate one or more populated template data structures; and
execute each of the one or more populated template data structures to generate the code for the component of the computer architecture, wherein the code, when executed in the computer architecture, implements at least one function of the software application.

10. The system of claim 9, wherein
the plurality of computer architecture parameters define constraints and requirements of the computer architecture and the plurality of component parameters define constraints and requirements of the particular component; and
the code, when executed in the computer architecture, complies with (1) the constraints and requirements of the computer architecture and (2) the constraints and requirements of the particular component.

11. The system of claim 9, wherein the multiple layers include at least two of a microservices layer, a data layer, an integration layer, a security layer, an infrastructure layer, a domain layer, an application layer, and a presentation layer.

12. The system of claim 9, the software module further configured to:
identify a directory identifier from the plurality of component parameters included in the component blueprint container; and
write the code to a directory corresponding to the directory identifier.

13. The system of claim 12, the software module further configured to:
execute the software application in the computer architecture; and
call the code stored in the directory to implement the at least one function.

14. The system of claim 9, wherein the plurality of computer architecture parameters include a required metadata parameter with a list of values that are required for the specification data structure.

15. The system of claim 14, the software module further configured to:
identify the list of values from the computer architecture blueprint container;
determine that the specification data structure is valid if each value from the list of values is included in the specification data structure; and
determine that the specification data structure is invalid if at least one value from the list of values is not included in the specification data structure.

16. The system of claim 9, the software module further configured to:
generate, based on the generation of the code, a manifest data structure for the particular component that includes all files and directories generated for the particular component utilizing the computer architecture blueprint container and the component blueprint container;
utilize the manifest data structure to identify one or more selected files and directories that are included in the manifest data structure but are not generated based on a current execution of the software application; and
delete the one or more selected files and directories.

17. A non-transitory computer readable medium having software encoded thereon, the software when executed by one or more computing devices operable to:
receive a computer architecture blueprint container including a plurality of computer architecture parameters that define the computer architecture;
identify a component identifier from the plurality of computer architecture parameters, wherein the component identifier corresponds to a particular component in the computer architecture;
identify a component blueprint container corresponding to the component identifier, wherein the component blueprint container includes a plurality of component parameters that define the particular component;
identify a location identifier from the plurality of component identifiers, the location identifier indicating a location of one or more template data structures in the computer architecture, wherein each of the one or more template data structures is executable and defines an operation or configuration of the particular component when the particular component executes in the computer architecture;
receive a specification data structure including information defining interfaces, functionality, and constraints of interaction between different components in the computer architecture with the multiple layers;
replace at least one value from each of the one or more template data structure using information from the specification data structure to generate one or more populated template data structures; and
execute each of the one or more populated template data structures to generate the code for the component of the computer architecture, wherein the code, when executed in the computer architecture, implements at least one function of the software application.

18. The non-transitory computer readable medium of claim 17, wherein
the plurality of computer architecture parameters define constraints and requirements of the computer architecture and the plurality of component parameters define constraints and requirements of the particular component; and
the code, when executed in the computer architecture, complies with (1) the constraints and requirements of the computer architecture and (2) the constraints and requirements of the particular component.

19. The non-transitory computer readable medium of claim 17, wherein the plurality of computer architecture parameters include a required metadata parameter with a list of values that are required for the specification data structure.

20. The non-transitory computer readable medium of claim 19, the software when executed by one or more computing devices operable to:
identify the list of values from the computer architecture blueprint container;
determine that the specification data structure is valid if each value from the list of values is included in the specification data structure; and
determine that the specification data structure is invalid if at least one value from the list of values is not included in the specification data structure.
